(19) United States
(12) Patent Application Publication
(10) Pub. No.: US 2018/0097765 A1
(43) Pub. Date: Apr. 5, 2018

(54) DETECTING CONFLICTING COMMUNICATIONS GENERATED IN A WORKFLOW

(71) Applicant: International Business Machines Corporation, Armonk, NY (US)

(72) Inventors: JAMES E. BOSTICK, CEDAR PARK, TX (US); JOHN M. GANCI, JR., CARY, NC (US); MARTIN G. KEEN, CARY, NC (US); SARBAJIT K. RAKSHIT, KOLKATA (IN)

(21) Appl. No.: 15/281,246

(22) Filed: Sep. 30, 2016

(51) Int. Cl. H04L 12/58; H04L 12/927

(52) U.S. Cl. CPC H04L 51/26; H04L 51/22; H04L 47/805

(57) ABSTRACT

A method, system, and/or computer program product conserves network bandwidth by blocking contrary electronic messages. One or more processors retrieve and analyze a pending electronic message by parsing and analyzing unstructured text within the pending electronic message in order to determine a meaning of the pending electronic message. The processor(s) retrieve one or more previous electronic messages and analyze them by parsing and analyzing unstructured text within the one or more previous electronic messages in order to determine a meaning of the one or more previous electronic messages. In response to determining that the meaning of the pending electronic message is contrary to the meaning of the one or more previous electronic messages, the processor(s) block the pending electronic message from being placed on the network for transmission from the sender to the receiving user in order to prevent contrary electronic messages from wasting bandwidth on the network.

### BACKGROUND

The present disclosure relates to the field of computers, and particularly to computers that communicate via a network. More particularly, the present disclosure relates to computers that generate electronic communication messages within a workflow.

### SUMMARY

In one or more embodiments of the present invention, a method conserves network bandwidth by blocking contrary electronic messages. One or more processors retrieve a pending electronic message before the pending electronic message is transmitted over a network from a sender to a receiving user. The processor(s) analyze the pending electronic message before the pending electronic message is transmitted over the network from the sender to the receiving user, where analyzing the pending electronic message is performed by parsing and analyzing unstructured text within the pending electronic message in order to determine a meaning of the pending electronic message. The processor(s) retrieve one or more previous electronic messages that have been previously sent from the sender to the receiving user, and then analyze the one or more previous electronic messages that have been previously sent from the sender to the receiving user. The processor(s) analyze the one or more previous electronic messages by parsing and analyzing unstructured text within the one or more previous electronic messages in order to determine a meaning of the one or more previous electronic messages. The processor(s) determine whether the meaning of the pending electronic message is contrary to the meaning of the one or more previous electronic messages. In response to determining that the meaning of the pending electronic message is contrary to the meaning of the one or more previous electronic messages, the processor(s) block the pending electronic message from being placed on the network for transmission from the sender to the receiving user in order to prevent contrary electronic messages from wasting bandwidth on the network.

In one or more embodiments of the present invention, the method is implemented as a computer program product and/or in a system.

### BRIEF DESCRIPTION OF THE DRAWINGS

FIG. 1 depicts an exemplary system and network in which the present disclosure may be implemented;

FIG. 2 illustrates a high-level flow chart of customer communications being analyzed in accordance with one or more embodiments of the present invention;

FIG. 3 depicts various communication devices utilized in one or more embodiments of the present invention to communicate electronic messages;

FIG. 4 illustrates exemplary past customer communications between a vendor and a customer as utilized by one or more embodiments of the present invention;

FIG. 5 depicts an exemplary pending new customer communication between the vendor and the customer as utilized by one or more embodiments of the present invention;

FIG. 6 illustrates an inconsistency between a pending new customer communication and a past customer communication as used in an example of one or more features of the present invention;

FIG. 7 is a high-level flow chart of one or more steps performed by one or more processors to conserve network bandwidth by preventing contrary electronic messages from wasting bandwidth on the network;

FIG. 8 depicts a cloud computing environment according to an embodiment of the present invention; and

FIG. 9 depicts abstraction model layers of a cloud computer environment according to an embodiment of the present invention.

### DETAILED DESCRIPTION

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

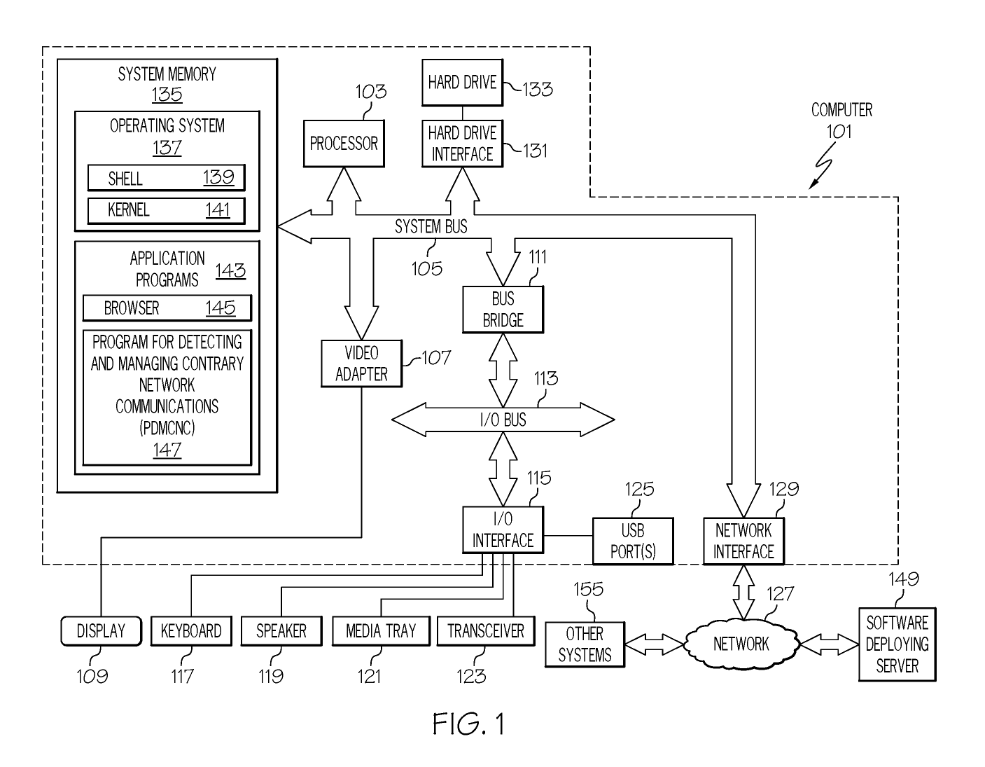

With reference now to the figures, and in particular to FIG. 1, there is depicted a block diagram of an exemplary system and network that may be utilized by and/or in the implementation of the present invention. Some or all of the exemplary architecture, including both depicted hardware and software, shown for and within computer 101 may be utilized by software deploying server 149 and/or other systems 155 shown in FIG. 1.

Exemplary computer 101 includes a processor 103 that is coupled to a system bus 105. Processor 103 may utilize one or more processors, each of which has one or more processor cores. A video adapter 107, which drives/supports a display 109 (which may be a touch-screen display capable of detecting touch inputs onto the display 109), is also coupled to system bus 105. System bus 105 is coupled via a bus bridge 111 to an input/output (I/O) bus 113. An I/O interface 115 is coupled to I/O bus 113. I/O interface 115 affords communication with various I/O devices, including a keyboard 117, a mouse 119, a media tray 121 (which may include storage devices such as CD-ROM drives, multi-media interfaces, etc.), and external USB port(s) 125. While the format of the ports connected to I/O interface 115 may be any known to those skilled in the art of computer architecture, in one embodiment some or all of these ports are universal serial bus (USB) ports.

As depicted, computer 101 is able to communicate with a software deploying server 149 and/or other devices/systems using a network interface 129. Network interface 129 is a hardware network interface, such as a network interface card (NIC), etc. Network 127 may be an external network such as the Internet, or an internal network such as an Ethernet or a virtual private network (VPN). In one or more embodiments, network 127 is a wireless network, such as a Wi-Fi network, a cellular network, etc.

A hard drive interface 131 is also coupled to system bus 105. Hard drive interface 131 interfaces with a hard drive 133. In one embodiment, hard drive 133 populates a system memory 135, which is also coupled to system bus 105. System memory is defined as a lowest level of volatile memory in computer 101. This volatile memory includes additional higher levels of volatile memory (not shown), including, but not limited to, cache memory, registers and buffers. Data that populates system memory 135 includes computer 101's operating system (OS) 137 and application programs 143.

OS 137 includes a shell 139, for providing transparent user access to resources such as application programs 143. Generally, shell 139 is a program that provides an interpreter and an interface between the user and the operating system. More specifically, shell 139 executes commands that are entered into a command line user interface or from a file. Thus, shell 139, also called a command processor, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 141) for processing. While shell 139 is a text-based, line-oriented user interface, the present invention will equally well support other user interface modes, such as graphical, voice, gestural, etc.

As depicted, OS 137 also includes kernel 141, which includes lower levels of functionality for OS 137, including providing essential services required by other parts of OS 137 and application programs 143, including memory management, process and task management, disk management, and mouse and keyboard management.

Application programs 143 include a renderer, shown in exemplary manner as a browser 145. Browser 145 includes program modules and instructions enabling a world wide web (WWW) client (i.e., computer 101) to send and receive network messages to the Internet using hypertext transfer protocol (HTTP) messaging, thus enabling communication with software deploying server 149 and other systems.

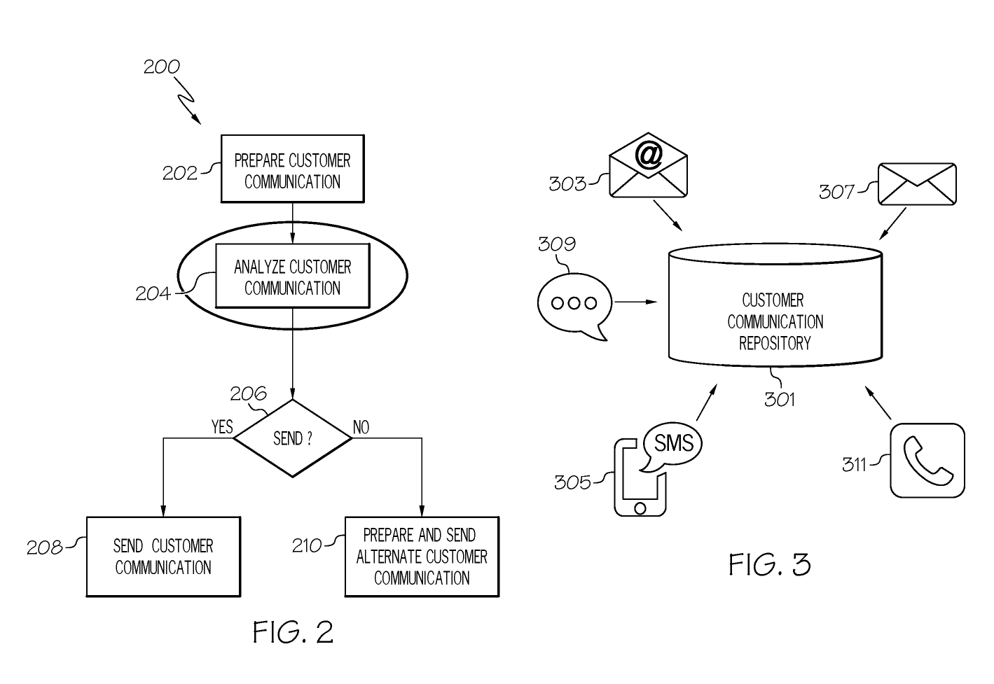

Application programs 143 in computer 101's system memory (as well as software deploying server 149's system memory) also include a Program for Detecting and Managing Contrary Network Communications (PDMCNC) 147. PDMCNC 147 includes code for implementing the processes described below, including those described in FIGS. 2-6. In one embodiment, computer 101 is able to download PDMCNC 147 from software deploying server 149, including in an on-demand basis, wherein the code in PDMCNC 147 is not downloaded until needed for execution. In one embodiment of the present invention, software deploying server 149 performs all of the functions associated with the present invention (including execution of PDMCNC 147), thus freeing computer 101 from having to use its own internal computing resources to execute PDMCNC 147.

The hardware elements depicted in computer 101 are not intended to be exhaustive, but rather are representative to highlight essential components required by the present invention. For instance, computer 101 may include alternate memory storage devices such as magnetic cassettes, digital versatile disks (DVDs), Bernoulli cartridges, and the like. These and other variations are intended to be within the spirit and scope of the present invention.

As disclosed herein, one or more embodiments of the present invention present a method for analyzing communications to be sent to a customer as generated by a business process workflow. When a communication is created, but before it is sent, the communication is analyzed to check if it conflicts with prior communications, and thus is not inappropriate (contrary), based upon the content of existing communications. Furthermore, based upon the content of communications and a user's prior history, the system can predict a best channel on which to send a communication.

Business process workflows frequently result in generating communications that are delivered to a customer. These communications include emails, letters, text messages, and mobile notifications. Examples of such communications include: reminding a customer of an action they need to take (such as paying their bill); informing a customer of a promotional offer that fits that customer's profile; etc. Such communications are the result of a dedicated business process workflow that is run in isolation from other processes. For example a business process workflow that generates communications related to promotional offers may not be linked to a business process workflow that generates communications related to billing reminders.

The customer is the single recipient of all of these communications generated from multiple isolated business process workflows, which can result in communications that are conflicting/inconsistent/contrary to prior communications, are inappropriate, and/or are likely to lead to an unhappy customer experience. Furthermore, such communications tie up bandwidth, since they are improper/unnecessary. The following communications describe exemplary conflicting and inappropriate communications.

Conflicting communications—A communication with a customer conflicts with prior communications sent to a customer. For example, assume that message #1 requested the customer return an item, message #2 acknowledged receipt of said item, and message #3 indicated the item was not returned. Thus, message #2 conflicts with messages #1 and #3.

Inappropriate communications—A communication with a customer is inappropriate in the context of prior communications sent to a customer. For example, if a promotional offer is made to a customer when previous communications indicate the customer is not interested in this specific promotion, then that promotional offer is inappropriate.

Both conflicting communications and inappropriate communications may be considered to be contrary communications, since they are contrary to the purpose/mission of the sender.

The present invention presents an additional step to insert into a business process workflow before sending a current communication to a customer. This automated step analyzes the current communication with other previous communications that were sent to the customer, in order to determine if the current message is conflicting with previous communications or is inappropriate. If such a situation is detected, a step is inserted into the business process to review the communication before sending the communication to the customer, thereby preventing network bandwidth waste. The invention can also predict, for a given individual and a given communication, which communication channel is best for customer satisfaction and action ability.

Thus, one or more embodiments of the present invention describe an additional step that can be incorporated into any business process workflow that generates communications with customers. When a communication is created, but before it is sent, the communication is analyzed to check whether it conflicts with prior communications, and is not inappropriate. Also, based upon the content of the communication and a user's prior history, the system can determine the best channel to send the communication.

For example, as shown in the flowchart 200 in FIG. 2, assume that the business process has prepared a customer communication (e.g., an electronic message transmitted over a network), as shown in block 202. The novel step presented in block 204 will analyze that customer communication and will decide whether or not to send it to the customer (query block 206) depending on whether or not it is contrary to (conflicts with, contradicts, is inappropriate, etc.) earlier customer communications between the entity that prepared the current customer communication (block 202) and the communications recipient (e.g., the customer).

If there is no conflict/contradiction between the present and earlier communications, then the electronic message (customer communication) is sent to the customer. However, if there is a conflict/contradiction, then an alternate customer communication may be prepared and sent (block 210). However, in one or more embodiments, this alternate communication is either 1) not sent at all, or 2) sent on an alternate network.

In one or more embodiments of the present invention, the system analyzes all communications sent to, and received from, customers across an entire enterprise, and then classifies these communications into categories and actions through use of analytics techniques including Natural Language Processing (NLP), Natural Language Classification (NLC), and Relationship Extraction (RE). For example, assume that computer 101 is used by a vendor to send electronic messages to customers that are using other systems 155 shown in FIG. 1. As discussed herein, the computer 101 will analyze both past communications and a pending communication using NLP, NLC, RE, etc. in order to determine the content (i.e., meaning) of the communications. In one or more embodiments of the present invention, different past communications are classified and stored according to their classifications. Thus, when a new (pending) communication is introduced, its classification is then matched to other past communications.

For example, assume that a pending communication between a vendor and a customer is related to “Product A”, and is classified as such. In order to determine whether this pending communication conflicts with other communications about “Product A” between the vendor and the customer, only past communications between the vendor and the customer related to “Product A” are evaluated, in order to see if there is a conflict between the pending communication and the past communications between the vendor and the customer related to “Product A”.

Thus, one or more embodiments of the present invention identify conflicting and/or inappropriate communications, based upon the analysis of the content of prior communications with a given customer.

The processes described herein thus provide insights into the optimal communication channel to send a given communication based on analysis of past history, actionability, and tone analysis.

In one or more embodiments of the present invention, the system (e.g., computer 101 shown in FIG. 1) prefigures the customer communication repository 301 shown in FIG. 3. That is, communications sent to customers and communications received from customers are stored in textual form in customer communication repository 301. Communications between the vendor and the customers include: Emails 303; Text messages 305; Letters 307; Online chat conversations 309; and Telephone conversations 311 (transcribed to text).

These communications are stored across business units and channels at a company to ensure that the company has a single repository (e.g., customer communication repository 301) of all communications sent to a customer, and communications received from a customer.

Stage 1—Analysis and Classification of Customer Communications

In Stage 1, customer conversations stored in the customer communication repository 301 are analyzed for content and classified based upon this analysis. In one or more embodiments, this is implemented in the following steps:

Extraction of primary communication purpose through Natural Language Processing—Communications sent to customers include information that goes beyond the primary purpose of the communication. Using Natural Language Processing (NLP), this extraneous information is removed (e.g., by computer 101), thus leaving only information key to the primary purpose of the communication. For example, consider the message “We hope you are enjoying your new mobile device. As part of your phone upgrade program, we requested that you return to us your old mobile device to avoid further charges. However, we have not received your old mobile device, and therefore will have to charge you an additional $200.00.” NLP will identify “We hope you are enjoying your new mobile device.” as providing no relevant information. However, the passage “As part of your phone upgrade program, we requested that you return to us your old mobile device to avoid further charges. However, we have not received your old mobile device, and therefore will have to charge you an additional $200.00.” provides the information of the fact that the customer is part of a “phone upgrade program”, that the vendor has “not received your old mobile device”, and is therefore going to charge the customer “an additional $200.00.” These elements are thus identified as the key issues from the message.

Classification of communication through Natural Language Classifier—With a communication distilled to its primary purpose, Natural Language Classifier analytics are used to categorize the message into classifications such as the following:

Message recipient—Was this message sent to a customer from a company, or sent to a company from a customer? In the example above, the message was from the company (vendor) to the customer.

Primary category—Is this communication requesting information, providing information, promoting content, and/or another action? In the example above, the communication provides information to the customer reminding the customer that he/she is in the “phone upgrade program”.

Secondary categories—Additional categories related to the communication. In the example above, the communication reminded the customer that a previous request has not been actioned (“we requested that you return to us your old mobile device to avoid further charges . . . we have not received your old mobile device”) and that additional steps have been taken by the vendor (“charge you an additional $200.00”).

Relationship to prior and future communications—Each communication is analyzed using a Relationship Extractor to determine the relationship to other communications. This enables the system to keep track of:

Which communications have already been sent to a customer;
Which communications were subsequently sent to a customer; and
Communications received from a customer in response to sent communications.

This analysis is completed for each communication in the Customer Communication Repository 301 shown in FIG. 3, and is continually updated as new communications are added to the repository.

Stage 2—Analysis for Conflicting/Inappropriate Communications

This stage is executed after a business process workflow has created a communication to send to a customer and before that communication is sent. In this stage:

The business process workflow checks that the communication it is about to send is appropriate before hitting the “send” button. The to-be-sent communication is input to this stage, and is broken down into classifications as described in Stage 1. The system compares the classified communication to be sent to a customer with prior communications.

The classifications are compared and processed using Natural Language Processing to look for:

Conflicting communications—Conflict between to-be-sent communication and prior communications. In the example above, assume that prior communication states a device has been returned, but to-be-sent communication states the same device has not been returned.

Inappropriate communications—Content of to-be-sent communication does not reflect prior communications. For example, to-be-sent communication may consist of a promotion to “upgrade your phone made by Company A”, but prior communications indicate that the customer has a phone made by Company X.

If the system detects a conflicting or inappropriate communication, a flag is raised in the business process workflow for a task to investigate the communication. The communication is not sent until the task has approved the communication as-is, modified the communication based upon the feedback received in this stage, or cancelled the communication.

Stage 3—Insights into Preferred Communication Channels

In addition to checking that a given communication does not conflict or is inappropriate with prior communications, the system can recommend the best communication channel to use to send the communication. For example, the system may determine which is the best channel to send this communication (email, text message, phone) to maximize customer satisfaction, utilize the least crowded network, etc. That is, if the vendor and customer have been communicating over a cellular channel that is overloaded (thus causing messages to be dropped), then the system may switch to an Internet connection to exchange messages (e.g., text messages).

To perform this analysis (used to determine the best communication channel to use), the system (e.g., computer 101 shown in FIG. 1) considers past communications sent to a customer, and responses from that customer. These are all stored in the Customer Communication Repository 301. By analyzing past communications to and from one individual in particular, and analyzing all responses in aggregate, the system can provide a weighted recommendation of the best communication channel to use for a to-be-sent communication.

The following techniques are used in one or more embodiments of the present invention to provide this recommendation:

General actionable success rate of previous communications—By analyzing which past communications have resulted in action, the system will learn which communication channels are most effective in general. For example, previous communications by email may have resulted in the requested action in 2 out of 7 attempts with a given customer, but communications by telephone have resulted in the requested action in 3 out of 4 attempts.

Action-specific success rate of previous communications—The system can learn which communication channels are most efficient for a specific classification of message. For example, the system can learn than an individual responds best to billing communications via email and promotional communications via text message. The system can also aggregate this across all communications, to learn in general for all customers which communication channel has the best response rate for a given classification.

Satisfaction rate of previous communications—The system can measure how well received prior communications have been. Using Tone Analyzer analysis (i.e., analyzing the tone/mood of the communication based on keywords that indicate certain tones such as anger (never) or being unsure (maybe), etc.), the system can process the tone of a communication from a customer in response to a message the customer has sent in order to detect his/her emotional response. By comparing emotional responses to different communication channels, the system can learn which communications are best received over which channels. This can also be applied to a specific individual or across all customer communications on aggregate.

Sequential analysis of communications—By analyzing a series of communications, the system can learn which channel will be most effective in the next step in a series. For example, the system may learn that when an initial communication has been sent over email, the most effective channel for a reminder communication is via text message. This is determined by studying the responses to prior communications, either from a specific individual or across all customer communications on aggregate.

The result of this stage is a weighted recommendation for the best channel on which to send the communication.

Stage 4—Sending of Communication

In this stage a decision is made as to whether the communication should be sent to the customer, and if so what the content should be and which communication channel used.

If Stage 2 highlights a conflicting or inappropriate communication, a task is raised in the business process workflow requesting further investigation. The system shows the nature of the conflict/inappropriate content and a process is undertaken to send the communication as-is, modify the communication, or cancel the communication.

If Stage 3 highlights a more preferred communication channel, either this channel is automatically used, or a task in the business process workflow is raised to approve the change in communication channel. The communication is then sent using this channel.

Thus, as described herein, one or more embodiments of the present invention utilize unstructured customer communications stored in a central Customer Communication Repository. This Customer Communication Repository (e.g., customer communication repository 301 shown in FIG. 3) includes emails, SMS messages, letters, and transcripted telephone communications with customers.

The present invention performs an analysis of each communication in the Customer Communication Repository by breaking the communication down into classifications and relationships. The following analytic techniques are used during this stage:

Natural Language Processing to remove extraneous information, leaving only key wording relating to the content of the message;

Natural Language Classifier to take this key wording and classify it into primary category, communication content, and intended action; and

Relationship Extraction to identify links between communications (for example to establish multiple communications that together form a conversation).

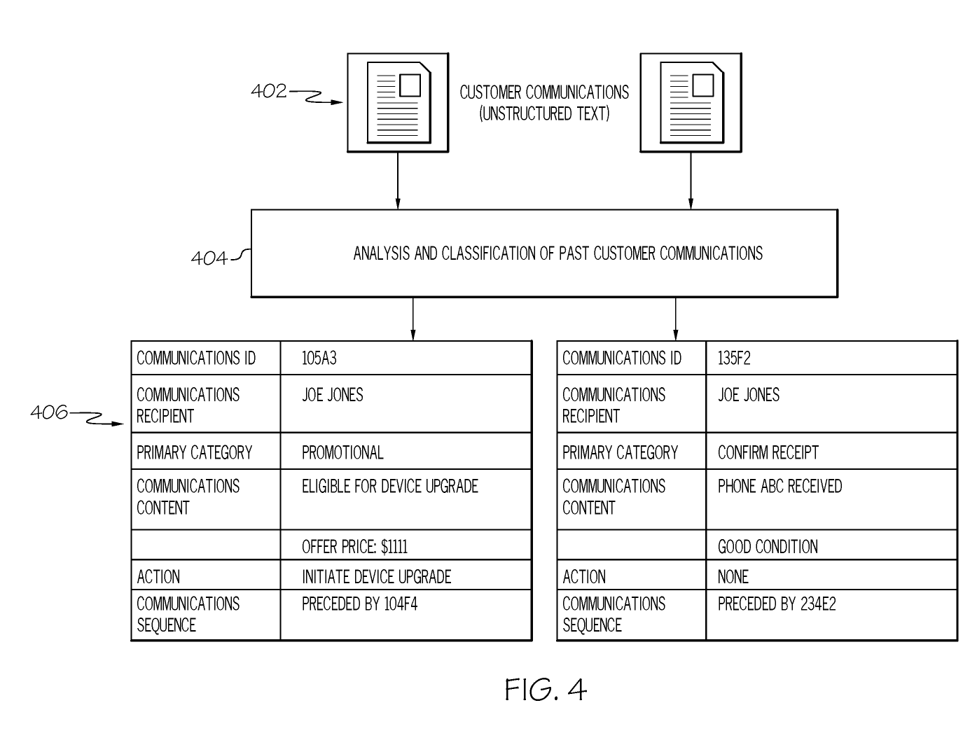

The results of these analytics are a series of metrics for each communication as shown in FIG. 4-FIG. 6). As shown in FIG. 4, past communications 402 between the vendor and a particular customer (“Joe Jones”) are analyzed (block 404), resulting in past communication metrics files 406 (which are stored in the customer communication repository 301 shown in FIG. 3).

As shown in FIG. 5, this process is utilized again when a new communication 501 is scheduled to be sent to a customer, as shown in block 503, thus generating a new set of metric files 505 for the new communication 501.

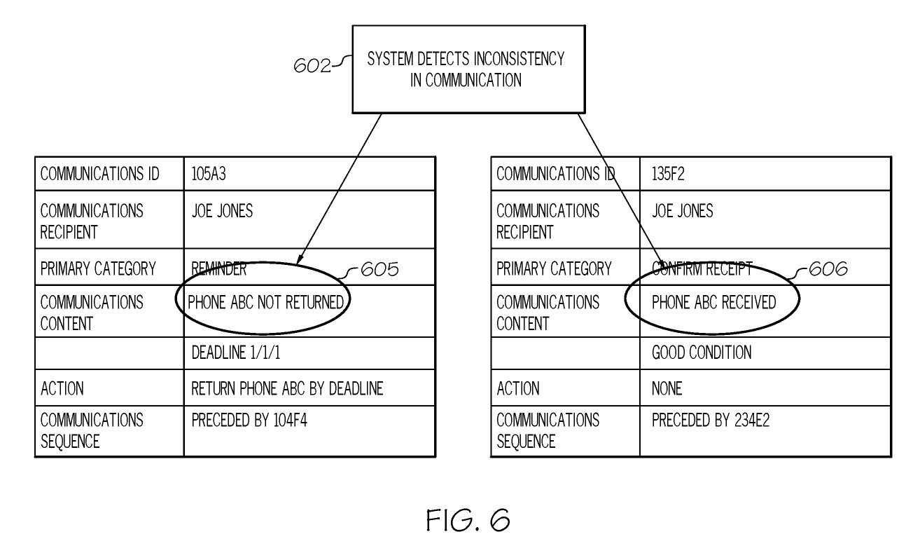

The system then utilizes Comparative Analysis to identify potential conflicts or inappropriate information between the communication to-be-sent (new communication 501) and the previous communications (past communications 402) with the same customer by comparing the analysis results from each message. As shown in FIG. 6, this analysis (block 602) finds two contradicting statements, shown as contradicting statement 605 (from the new set of metric files 505 for the new communication 501 shown in FIG. 5) and its corresponding contradicting statement 606 (from past communication metrics file 406 for past communications 402 shown in FIG. 4).

This contradiction raises a flag, such that the communication is not automatically sent, but rather a task is undertaken by the system to resolve how to handle the discrepancy.

Furthermore, in one or more embodiments, the present invention also uses the detection of inappropriate content (such as promotional offers that are not consistent with previous communications with a customer) in order to provide insights and recommendations as to the appropriate channel to send a communication based on the analysis of the metrics shown above compared to a customer's response to those metrics.

With reference now to FIG. 7, a high-level flow chart of one or more steps performed by one or more processors to conserve network bandwidth by preventing contrary electronic messages from wasting bandwidth on the network is presented.

After initiator block 701, one or more processors (e.g., within computer 101 shown in FIG. 1) retrieve a pending electronic message (i.e., before the pending electronic message is transmitted), as described in block 703. The electronic message is scheduled/slated to be transmitted over a network (e.g., network 127 shown in FIG. 1) from a sender (e.g., computer 101) to a receiving user (e.g., a user of one of the other systems 155 shown in FIG. 1).

As described in block 705, one or more processors analyze the pending electronic message before the pending electronic message is transmitted over the network from the sender to the receiving user. As described herein in one or more embodiments of the present invention, analyzing the pending electronic message is performed by parsing (e.g., into various phrases and parts of speech using the analytical processes described herein) and analyzing (e.g., according to contextual meaning, etc.) unstructured text (i.e., words and phrases) within the pending electronic message in order to determine a meaning of the pending electronic message. For example, this parsing/analysis may determine the meaning of the pending electronic message to be that a customer has not returned their trade-in phone (see FIG. 5).

As described in block 707, one or more processors retrieve one or more previous electronic messages that have been previously sent from the sender to the receiving user (e.g., past communications 402 shown FIG. 4).

As described in block 709, one or more processors then analyze the one or more previous electronic messages that have been previously sent from the sender to the receiving user (see block 404 in FIG. 4). As described herein, analyzing the one or more previous electronic messages is performed by parsing and analyzing unstructured text within the one or more previous electronic messages in order to determine a meaning of the one or more previous electronic messages.

As described in block 711, one or more processors determine whether the meaning of the pending electronic message contradicts the meaning of the one or more previous electronic messages (see exemplary FIG. 6).

Based on the results of query block 713, if the meaning of the pending electronic message contradicts the meaning of the one or more previous electronic messages, then one or more processors block the pending electronic message from being placed on the network for transmission from the sender to the receiving user in order to prevent inappropriate electronic messages from wasting bandwidth on the network, as described in block 715.

However, if the meaning of the pending electronic message does not contradict the meaning of the one or more previous electronic messages (query block 713), then one or more processors place the pending electronic message on the network for transmission from the sender to the receiving user, as described in block 717.

The flow-chart ends at terminator block 719.

In an embodiment of the present invention, the one or more previous electronic messages that were previously sent from the sender to the receiving user were sent on the network that was intended to be used for transmitting the pending electronic message from the sender to the receiving user. Thus, the bandwidth is conserved for a single network by simply blocking the pending electronic message from being sent over this single network.

However, in another embodiment, the one or more previous electronic messages that were previously sent from the sender to the receiving user were sent on a different network than the network that was intended to be used for transmitting the pending electronic message from the sender to the receiving user. Thus, network bandwidth may be allocated by either preventing the pending electronic message from being transmitted at all, or else it may be transmitted over a secondary network (e.g., a network that is reserved for messages that appear to be contrary to earlier electronic messages between the vendor and the customer).

In an embodiment of the present invention, the one or more previous electronic messages are all previous electronic messages that were previously sent from the sender to the receiving user. Thus, the system ensures catching any conflicting messages.

As such, an embodiment of the present invention utilizes one or more processors to addresses this issue by retrieving a subject heading of the pending electronic message; retrieving subject headings of the one or more previous electronic messages; comparing the subject heading of the pending electronic message to the subject headings of the one or more previous electronic messages; and in response to determining that the subject heading of the pending electronic message is a same subject heading as a subject heading of at least one of the one or more previous electronic messages, continuing to block the pending electronic message from being placed on the network for transmission from the sender to the receiving user. That is, the pending electronic message is only compared to past messages between the vendor/sender and the customer/recipient if there is a conflict in message addressed to the same subject that is identified in their subject headings (e.g., a “Subject” line in an e-mail, information in a communication packet header, etc.)

In an embodiment of the present invention, if the subject heading in the pending electronic message matches none of the subject headings in the previous electronic messages between the vendor/sender and the customer/recipient, then the pending electronic message is allowed to be placed on the network to the recipient. That is, one or more processors (e.g., from computer 101 shown in FIG. 1) will: retrieve a subject heading of the pending electronic message; retrieve subject headings of the one or more previous electronic messages; and compare the subject heading of the pending electronic message to the subject headings of the one or more previous electronic message. In response to determining that the subject heading of the pending electronic message matches none of the subject headings of the one or more previous electronic messages, the one or more processors will unblock the pending electronic message, thus allowing it to be placed on the network for transmission from the sender to the receiving user.

As described below, in one or more embodiments of the present invention the method and/or computer program product is implemented/provided as a cloud-based service.

As described herein, the present invention enables organizations to ensure that communications sent from one workflow are consistent and appropriate with communications sent from another workflow, thus optimizing network communications and usage of network resources.

The present invention may be implemented in one or more embodiments using cloud computing. Nonetheless, it is understood in advance that although this disclosure includes a detailed description on cloud computing, implementation of the teachings recited herein is not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

Referring now to FIG. 8, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-54N shown in FIG. 8 are intended to be illustrative only and that computing nodes 10 and cloud computing environment 50 can communicate with any type of computerized device over any type of network and/or network addressable connection (e.g., using a web browser).

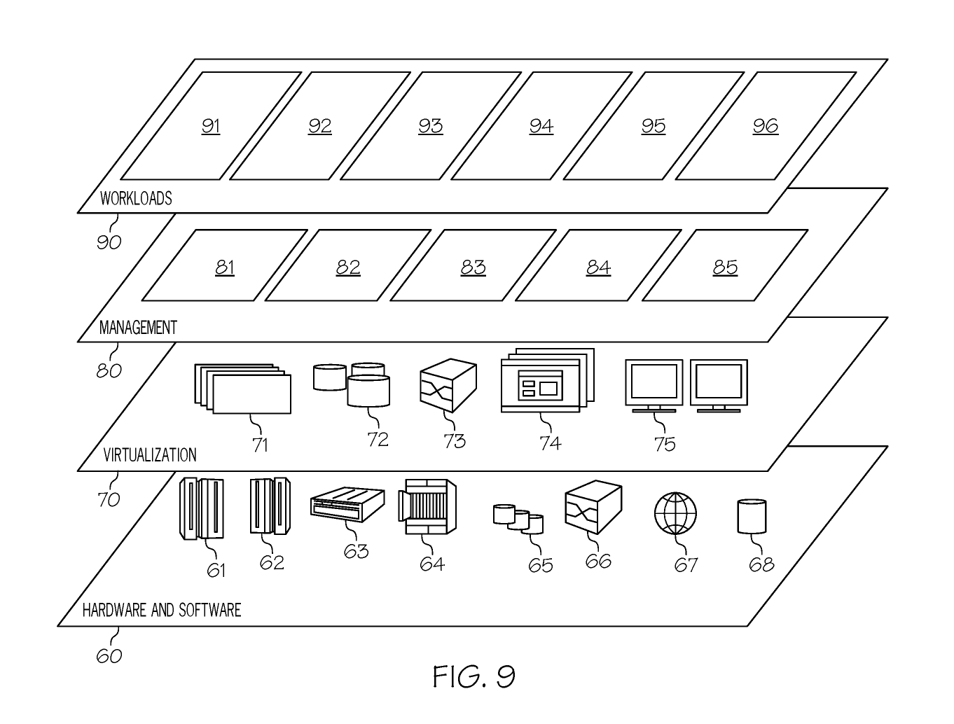

Referring now to FIG. 9, a set of functional abstraction layers provided by cloud computing environment 50 (FIG. 8) is shown. It should be understood in advance that the components, layers, and functions shown in FIG. 9 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and network bandwidth management processing 96, which performs one or more of the features of the present invention described herein.

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of various embodiments of the present invention has been presented for purposes of illustration and description, but is not intended to be exhaustive or limited to the present invention in the form disclosed. Many modifications and variations will be apparent to those of ordinary skill in the art without departing from the scope and spirit of the present invention. The embodiment was chosen and described in order to best explain the principles of the present invention and the practical application, and to enable others of ordinary skill in the art to understand the present invention for various embodiments with various modifications as are suited to the particular use contemplated.

Any methods described in the present disclosure may be implemented through the use of a VHDL (VHSIC Hardware Description Language) program and a VHDL chip. VHDL is an exemplary design-entry language for Field Programmable Gate Arrays (FPGAs), Application Specific Integrated Circuits (ASICs), and other similar electronic devices. Thus, any software-implemented method described herein may be emulated by a hardware-based VHDL program, which is then applied to a VHDL chip, such as a FPGA.

Having thus described embodiments of the present invention of the present application in detail and by reference to illustrative embodiments thereof, it will be apparent that modifications and variations are possible without departing from the scope of the present invention defined in the appended claims.

What is claimed is:

1. A method comprising:
retrieving, by one or more processors, a pending electronic message before the pending electronic message is transmitted over a network from a sender to a receiving user,
analyzing, by one or more processors, the pending electronic message before the pending electronic message is transmitted over the network from the sender to the receiving user, wherein analyzing the pending electronic message is performed by parsing and analyzing unstructured text within the pending electronic message in order to determine a meaning of the pending electronic message;
retrieving, by one or more processors, one or more previous electronic messages that were previously sent from the sender to the receiving user;
analyzing, by one or more processors, the one or more previous electronic messages that were previously sent from the sender to the receiving user, wherein analyzing the one or more previous electronic messages is performed by parsing and analyzing unstructured text within the one or more previous electronic messages in order to determine a meaning of the one or more previous electronic messages;
determining, by one or more processors, whether the meaning of the pending electronic message is contrary to the meaning of the one or more previous electronic messages; and
in response to determining that the meaning of the pending electronic message is contrary to the meaning of the one or more previous electronic messages, blocking, by one or more processors, the pending electronic message from being placed on the network for transmission from the sender to the receiving user in order to prevent contrary electronic messages from wasting bandwidth on the network.

2. The method of claim 1, further comprising:
in response to determining that the meaning of the pending electronic message does not contradict the meaning of the one or more previous electronic messages, placing, by one or more processors, the pending electronic message on the network for transmission from the sender to the receiving user.

3. The method of claim 1, wherein the one or more previous electronic messages that were previously sent from the sender to the receiving user were sent on the network that was intended to be used for transmitting the pending electronic message from the sender to the receiving user.

4. The method of claim 1, wherein the one or more previous electronic messages that were previously sent from the sender to the receiving user were sent on a different network than the network that was intended to be used for transmitting the pending electronic message from the sender to the receiving user.

5. The method of claim 1, wherein the one or more previous electronic messages are all previous electronic messages that were previously sent from the sender to the receiving user.

6. The method of claim 1, further comprising:
retrieving, by one or more processors, a subject heading of the pending electronic message;
retrieving, by one or more processors, subject headings of the one or more previous electronic messages;
comparing, by one or more processors, the subject heading of the pending electronic message to the subject headings of the one or more previous electronic messages; and
in response to determining that the subject heading of the pending electronic message is a same subject heading as a subject heading of at least one of the one or more previous electronic messages, continuing to block, by one or more processors, the pending electronic message from being placed on the network for transmission from the sender to the receiving user.

7. The method of claim 1, further comprising:
retrieving, by one or more processors, a subject heading of the pending electronic message;
retrieving, by one or more processors, subject headings of the one or more previous electronic messages;
comparing, by one or more processors, the subject heading of the pending electronic message to the subject headings of the one or more previous electronic messages; and
in response to determining that the subject heading of the pending electronic message matches none of the subject headings of the one or more previous electronic messages, unblocking, by one or more processors, the pending electronic message from being placed on the network for transmission from the sender to the receiving user.

8. The method of claim 1, wherein the method is implemented as a cloud-based service.

9. A computer program product comprising one or more computer readable storage mediums, and program instructions stored on at least one of the one or more storage mediums, the stored program instructions comprising:
program instructions to retrieve a pending electronic message before the pending electronic message is transmitted over a network from a sender to a receiving user,
program instructions to analyze the pending electronic message before the pending electronic message is transmitted over the network from the sender to the receiving user, wherein analyzing the pending electronic message is performed by parsing and analyzing unstructured text within the pending electronic message in order to determine a meaning of the pending electronic message;
program instructions to retrieve one or more previous electronic messages that were previously sent from the sender to the receiving user;
program instructions to analyze the one or more previous electronic messages that were previously sent from the sender to the receiving user, wherein analyzing the one or more previous electronic messages is performed by parsing and analyzing unstructured text within the one or more previous electronic messages in order to determine a meaning of the one or more previous electronic messages;
program instructions to determine whether the meaning of the pending electronic message is contrary to the meaning of the one or more previous electronic messages; and
program instructions to, in response to determining that the meaning of the pending electronic message is contrary to the meaning of the one or more previous electronic messages, block the pending electronic message from being placed on the network for transmission from the sender to the receiving user in order to prevent contrary electronic messages from wasting bandwidth on the network.

10. The computer program product of claim 9, wherein the one or more previous electronic messages that were previously sent from the sender to the receiving user were sent on a different network than the network that was intended to be used for transmitting the pending electronic message from the sender to the receiving user.

11. The computer program product of claim 9, wherein the one or more previous electronic messages are all previous electronic messages that were previously sent from the sender to the receiving user.

12. The computer program product of claim 9, further comprising:
program instructions to retrieve a subject heading of the pending electronic message;
program instructions to retrieve subject headings of the one or more previous electronic messages;
program instructions to compare the subject heading of the pending electronic message to the subject headings of the one or more previous electronic messages; and
program instructions to, in response to determining that the subject heading of the pending electronic message is a same subject heading as a subject heading of at least one of the one or more previous electronic messages, continue to block the pending electronic message from being placed on the network for transmission from the sender to the receiving user.

13. The computer program product of claim 9, further comprising:
program instructions to determine a subject heading of the pending electronic message;
program instructions to determine subject headings of the one or more previous electronic messages;
program instructions to compare the subject heading of the pending electronic message to the subject headings of the one or more previous electronic messages; and
program instructions to, in response to determining that the subject heading of the pending electronic message matches none of the subject headings of the one or more previous electronic messages, unblock the pending electronic message from being placed on the network for transmission from the sender to the receiving user.

14. The computer program product of claim 9, wherein the program instructions are provided as a service in a cloud environment.

15. A computer system comprising one or more processors, one or more computer readable memories, and one or more computer readable storage mediums, and program instructions stored on at least one of the one or more storage mediums for execution by at least one of the one or more processors via at least one of the one or more memories, the stored program instructions comprising:
program instructions to retrieve a pending electronic message before the pending electronic message is transmitted over a network from a sender to a receiving user,
program instructions to analyze the pending electronic message before the pending electronic message is transmitted over the network from the sender to the receiving user, wherein analyzing the pending electronic message is performed by parsing and analyzing unstructured text within the pending electronic message in order to determine a meaning of the pending electronic message;
program instructions to retrieve one or more previous electronic messages that were previously sent from the sender to the receiving user;
program instructions to analyze the one or more previous electronic messages that were previously sent from the sender to the receiving user, wherein analyzing the one or more previous electronic messages is performed by parsing and analyzing unstructured text within the one or more previous electronic messages in order to determine a meaning of the one or more previous electronic messages;
program instructions to determine whether the meaning of the pending electronic message is contrary to the meaning of the one or more previous electronic messages; and
program instructions to, in response to determining that the meaning of the pending electronic message is contrary to the meaning of the one or more previous electronic messages, block the pending electronic message from being placed on the network for transmission from the sender to the receiving user in order to prevent contrary electronic messages from wasting bandwidth on the network.

16. The computer system of claim 15, wherein the one or more previous electronic messages that were previously sent from the sender to the receiving user were sent on the network that was intended to be used for transmitting the pending electronic message from the sender to the receiving user.

17. The computer system of claim 15, wherein the one or more previous electronic messages that were previously sent from the sender to the receiving user were sent on a different network than the network that was intended to be used for transmitting the pending electronic message from the sender to the receiving user.

18. The computer system of claim 15, wherein the one or more previous electronic messages are all previous electronic messages that were previously sent from the sender to the receiving user.

19. The computer system of claim 15, further comprising:
program instructions to retrieve a subject heading of the pending electronic message;
program instructions to retrieve subject headings of the one or more previous electronic messages;
program instructions to compare the subject heading of the pending electronic message to the subject headings of the one or more previous electronic messages; and
program instructions to in response to determining that the subject heading of the pending electronic message is a same subject heading as a subject heading of at least one of the one or more previous electronic messages, continue to block the pending electronic message from being placed on the network for transmission from the sender to the receiving user.

20. The computer system of claim 15, further comprising:
program instructions to determine a subject heading of the pending electronic message;
program instructions to determine subject headings of the one or more previous electronic messages;
program instructions to compare the subject heading of the pending electronic message to the subject headings of the one or more previous electronic messages; and
program instructions to, in response to determining that the subject heading of the pending electronic message matches none of the subject headings of the one or more previous electronic messages, unblock the pending electronic message from being placed on the network for transmission from the sender to the receiving user.
